(19) United States
(12) Patent Application Publication
(10) Pub. No.: US 2022/0213326 A1
(43) Pub. Date: Jul. 7, 2022

(54) MIXTURE OF FUSED-RING AROMATIC PIGMENT AND POLYMER MATERIAL AND ITS PREPARATION METHOD AND DOWNSTREAM PRODUCT

(71) Applicant: CaiCai Technology Co., Ltd., Guangdong (CN)

(72) Inventors: Chen LI, Guangdong (CN); Wenshan WEI, Guangdong (CN); Ruomeng DUAN, Guangdong (CN); Yanfei ZHAO, Guangdong (CN); Zhihong LIU, Guangdong (CN); He TIAN, Guangdong (CN)

(73) Assignee: CaiCai Technology Co., Ltd., Guangdong (CN)

(21) Appl. No.: 17/704,005

(22) Filed: Mar. 25, 2022

Related U.S. Application Data
(63) Continuation of application No. PCT/CN2019/115570, filed on Nov. 5, 2019.

(30) Foreign Application Priority Data
Oct. 30, 2019 (CN) 201911047274.5

(51) Int. Cl. C09B 67/20; C09B 57/12; C08J 3/22; C08K 5/3447; C08K 5/3465

(52) U.S. Cl. CPC C09B 67/0063; C09B 57/12; C08K 5/3465; C08K 5/3447; C08J 3/226

(57) ABSTRACT

Disclosed are a mixture of a fused-ring aromatic pigment and a polymer material and its preparation method and downstream product. According to the method, different thermoplastic polymer materials can be selected and mixed with reactants for generating a fused-ring aromatic pigment; by adjusting the reaction molar ratio of the raw materials and the dosages of the raw materials in the whole reaction system, the mixture of the reactant and the polymer material can be extruded or kneaded to obtain a mixture of the fused-ring aromatic pigment and the polymer material in one step. Compared with the pigment, the raw material reactants of the pigment have better dispersity in the polymer material so that the pigment can be directly generated and uniformly dispersed in the polymer material through extruding or kneading.

### CROSS-REFERENCE TO RELATED APPLICATION

The present application is a continuation of international application of PCT application serial No. PCT/CN2019/115570 filed on Nov. 5, 2019, which claims the priority benefit of China application No. 201911047274.5 filed on Oct. 30, 2019. The entirety of each of the above-mentioned patent applications is incorporated herein by reference and made a part of this specification.

### BACKGROUND OF THE INVENTION

### 1. Technical Field

The invention relates to the technical field of pigments, and in particular, to a mixture of a fused-ring aromatic pigment and a polymer material and its preparation method and downstream product.

### 2. Description of Related Art

Fused-ring vat dyes have bright color and excellent fastness, especially in light fastness and solvent resistance. However, due to the poor dispersibility of fused-ring aromatic compounds in the production process, high-boiling and difficult-to-remove solvents are required, resulting in a large amount of waste liquid. Moreover, because the purification of dye molecules is also very difficult, such dyes have low reaction yield and high price, their processing technology is relatively more complex, which greatly limits the application and development of such dyes.

As disclosed in US20080139813, using metal catalysts such as ammonium molybdate, molybdenum oxide, molybdenum carbonyl, titanium carbonyl, iron carbonyl, etc., and in the presence of a solvent nitrogen methyl pyrrolidone (NMP), perylene-3,4,9,10-tetracarboxylic acid, 1,4,5,8-naphthalene-tetracarboxylic acid and its anhydride, and imide react with amine to obtain reaction products: perylene dianhydride and phenylenediamine. In the embodiments, the reaction yield is up to 96.7%, the whole reaction needs to be carried out at about 200° C., the reaction time is more than 20 hours, and after the reaction, the product needs to be washed and purified with NMP and sulfuric acid to obtain the final product, which is bound to produce a large amount of waste liquid containing NMP, sulfuric acid and bases.

US20070151478 discloses a method for synthesizing a black pigment by the reaction of perylene dianhydride or naphthalene dianhydride and aromatic diamine. According to the invention, high boiling point solvents such as nitrobenzene, trichlorobenzene, N,N-dimethylformamide (DMF) or the like are used to participate in a reaction at 150° C. to 250° C., using zinc chloride, zinc acetate, acetic acid, hydrochloric acid, piperazine, or the like as a catalyst. It can be seen that most of the reaction solvents designed under this condition are very toxic, and the waste liquid after the reaction will also cause damage to the environment.

As disclosed in WO2009074504, a mixing device is used to synthesize perylene dyes or pigments under the action of tetracarboxylic acids and their derivatives, amine compounds, additives, and wetting agents. Similarly, the synthesis takes a long time and requires a high temperature, alcohol solvents are used in the synthesis, and the crude product after the reaction needs to be purified by various solvents, acids and bases, which does not reduce the amount of waste liquid generated during the synthesis of such pigments.

As disclosed in CN108329466, in-situ polymerization is carried out to bond perylene tetracarboxylic dianhydride to the polymer chain of nylon 6 to obtain a nylon 6 material containing perylene dye. However, this reaction requires a high temperature and takes a long time, and the use of toxic organic solvents such as chloroform is not excluded.

EP0892018 reports that ordinary organic pigment molecules and polymerizable substances are mixed and heated, and then cooled to obtain a composite material of pigments and polymers. The pigment molecules used in this method have great limitations, and the pigment molecules are required to have functional substituents that can react. Moreover, most of the polymerizable substances are liquids at room temperature, so the processing of such materials requires the use of an extruder capable of liquid injection with higher processing performance. EP654711, EP542669 and EP456610 adopt similar methods to prepare fluorescent pigments. Since these preparation methods of pigments are not the real synthesis of the pigment molecules themselves, the waste liquid, waste solids and waste gas generated during the synthesis of the pigment molecules are not avoided. Similarly, J. APPL. POLYM. SCI. 2015, DOI: 10.1002/APP.42172 also reported the synthesis of polymerizable naphthalimide fluorescent dyes to prepare polyethylene-based fluorescent polymers, but the polymerizable naphthalimide also needs to be synthesized by traditional methods, and waste liquid cannot be avoided too.

### BRIEF SUMMARY OF THE INVENTION

Based on this, it is desired to provide a preparation method of a mixture of a fused-ring aromatic pigment and a polymer material with no need of purification or generation of three wastes. Its specific solution is as follows.

A preparation method of a mixture of a fused-ring aromatic pigment and a polymer material, including the following steps:

mixing a thermoplastic polymer material and reactants for forming a fused-ring aromatic pigment, and carrying out kneading or extruding to obtain a mixture of the fused-ring aromatic pigment and the polymer material, the reactants for forming the fused-ring aromatic pigment including an acid anhydride-functionalized fused-ring aromatic compound derivative, an o-diamine compound and a catalyst, a mass content of the fused-ring aromatic pigment in the mixture of the fused-ring aromatic pigment and the polymer material being 0.1% to 50%, a molar ratio of acid anhydride functional groups in the o-diamine compound and the acid anhydride-functionalized fused-ring aromatic compound derivative being 1:(1 to 1.1), a molar ratio of the catalyst to the acid anhydride functionalized fused-ring aromatic compound derivative being (0.01 to 10):1.

In one embodiment, the acid anhydride-functionalized fused-ring aromatic compound derivative is at least one of the following compounds:

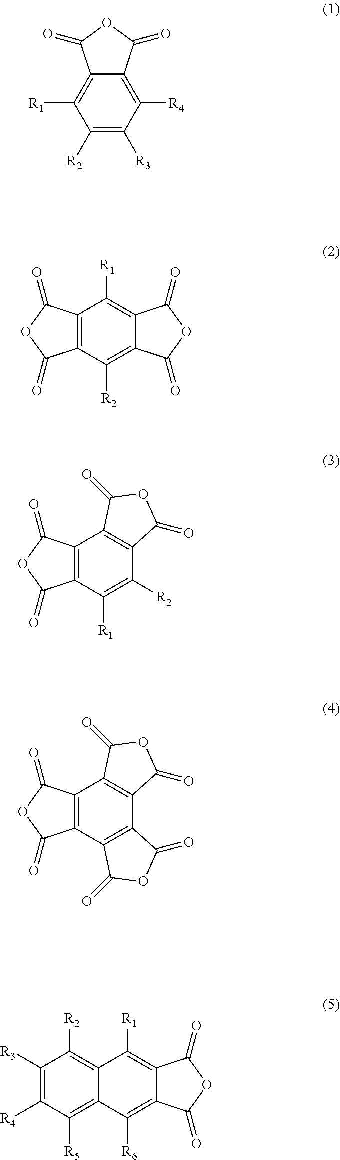

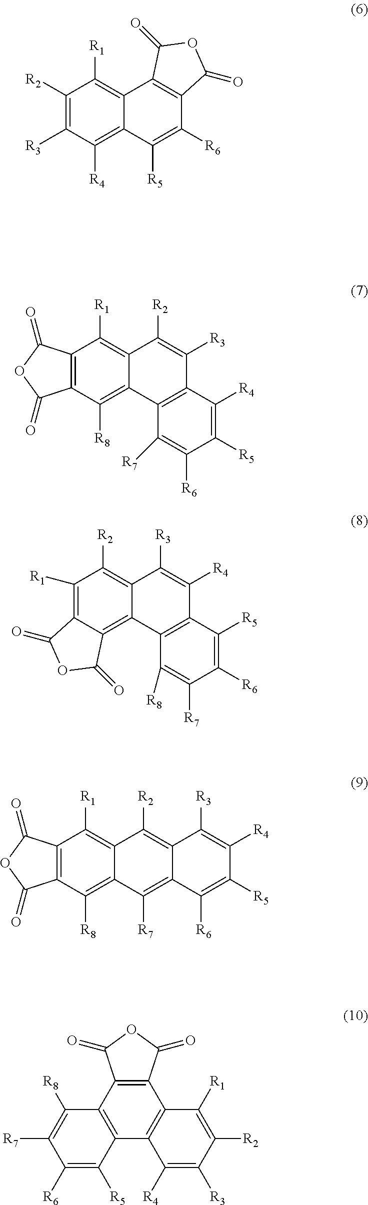

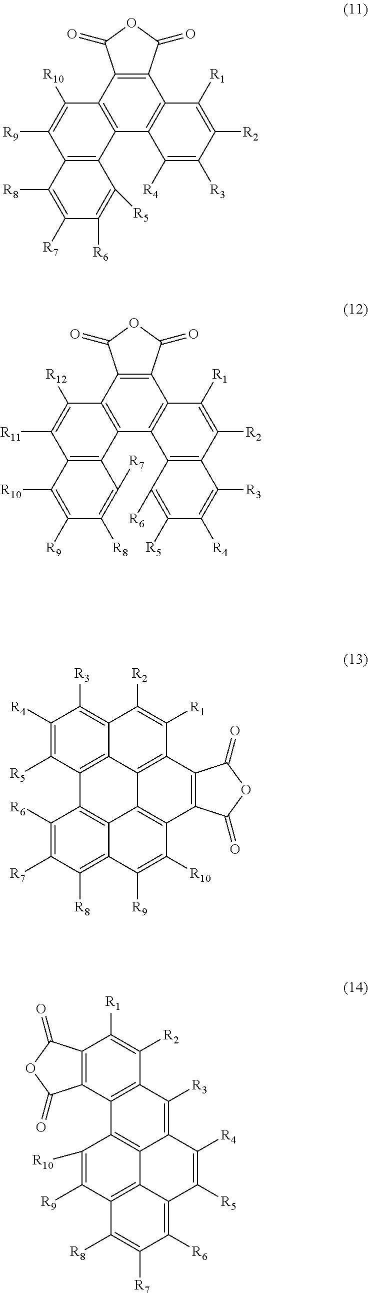

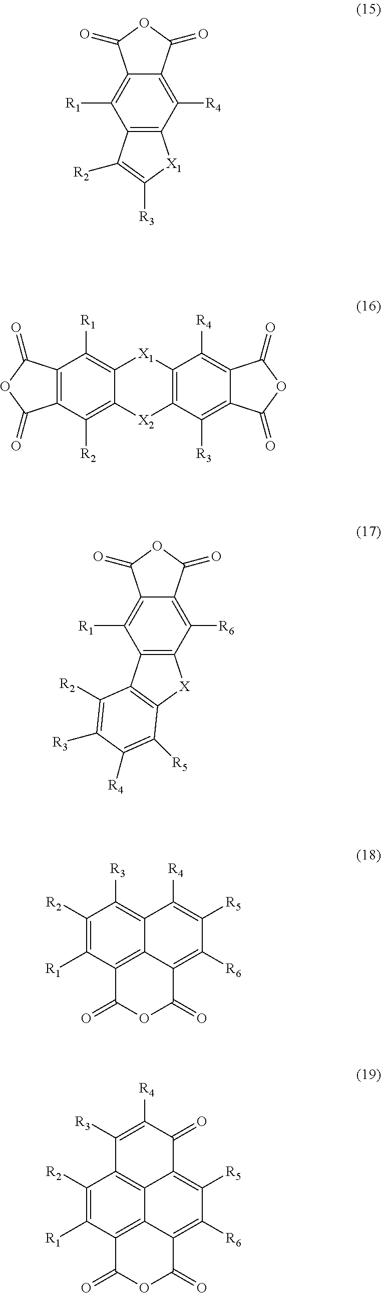

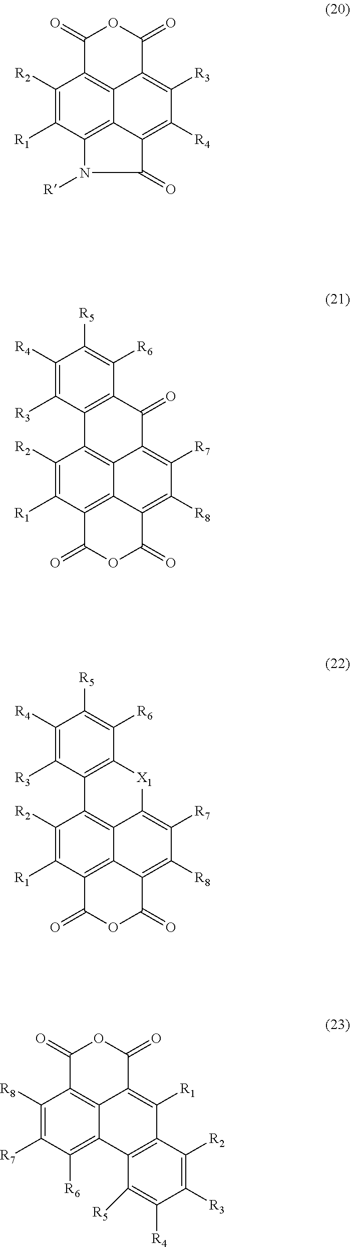

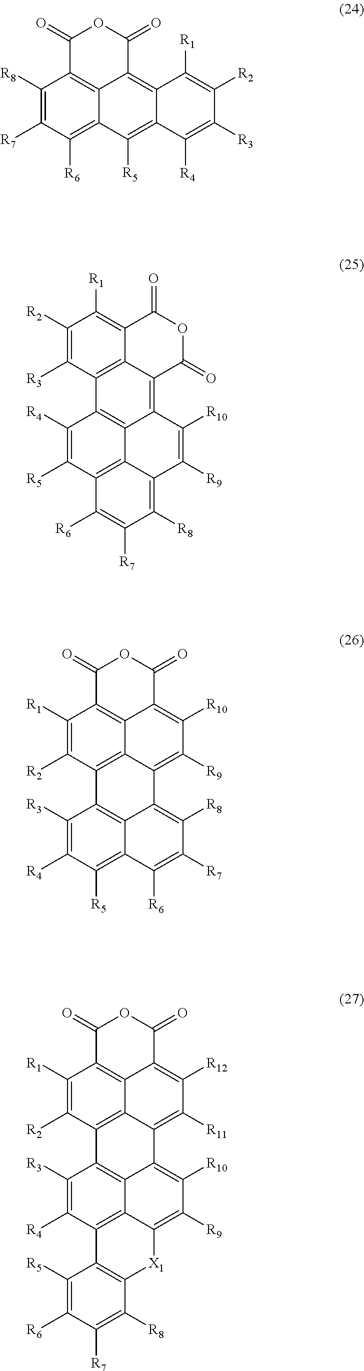

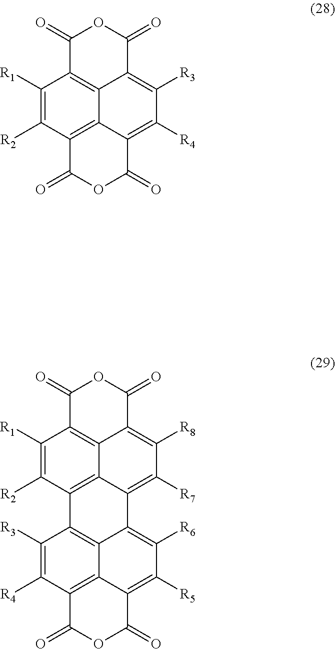

wherein, R₁ to R₁₂ each independently represents one of H, halogen, amido group, substituted amido group, alkyl group with 1 to 30 carbon atoms, alkoxy group with 1 to 20 carbon atoms, phenolic hydroxyl group, substituted phenolic hydroxyl group, phenyl group, substituted phenyl group, naphthyl group, substituted naphthyl group, mercapto group, substituted mercapto group, cyano group, silicyl group, carboxylic ester group, sulfonic acid group, sulphonate group, phosphoric acid group, and phosphate group;

R′ represents one of H, alkyl group with 1 to 30 carbon atoms, alkoxy group with 1 to 20 carbon atoms, phenyl group, substituted phenyl group, naphthyl group, substituted naphthyl group, and silicyl group;

X₁ and X₂ each independently represents one of CH₂, CHR″, CR″R′″, NR″, O, S, S═O and SO₂, and R″ and R′″ each independently represents one of H, alkyl group with 1 to 30 carbon atoms, alkoxy group with 1 to 20 carbon atoms, and substituted aryl.

In one embodiment, the o-diamine compound is at least one of the following compounds:

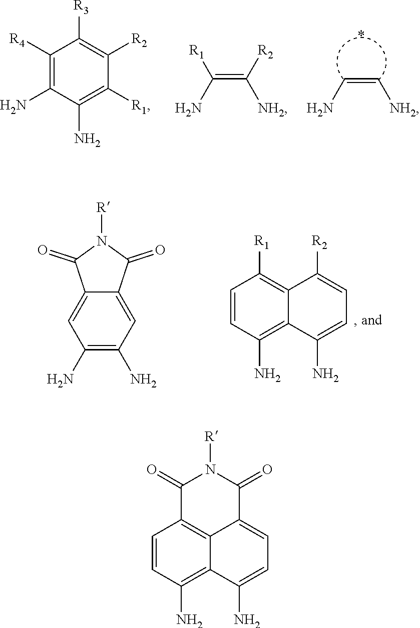

wherein, R₁, R₂, R₃, and R₄ each independently represents at least one of H, halogen, cyano group, nitro group, aldehyde group, carboxyl group, acid anhydride, amide, imide, ester group, alkyl group, alkoxy group, and mercapto group;

R′ independently represents one of H, alkyl group with 1 to 30 carbon atoms, alkoxy group with 1 to 20 carbon atoms, and substituted aryl;

X is a five- or six-membered ring structure containing S, N, O, CO, SO, SO₂ or C═C groups.

In one embodiment, the catalyst is at least one of a water scavenger, a Lewis acid, a Lewis base, and a metal oxide.

In one embodiment, the extruding temperature is 120° C. to 330° C. in a feeding section, 150° C. to 360° C. in an extruding section, and 180° C. to 380° C. in a sample discharging section along a material advancing direction.

The application further provides a mixture of a fused-ring aromatic pigment and a polymer material prepared by any one of the above-mentioned preparation methods.

In addition, the application further provides a downstream product of the above-mentioned mixture of a fused-ring aromatic pigment and a polymer material, such as a crude color masterbatch, a color masterbatch product and a polymer pigment. The specific solutions are as follows.

A crude color masterbatch obtained by cooling, drying and dicing the above-mentioned mixture of a fused-ring aromatic pigment and a polymer material.

A color masterbatch product obtained by mixing raw materials of the above-mentioned mixture of a fused-ring aromatic pigment and a polymer material with additives, and carrying out extruding, cooling, drying and dicing; or by mixing the above-mentioned crude color masterbatch with additives and then carrying out extruding, cooling, drying and dicing.

In one embodiment, the color masterbatch product has a particle size of 200 μm to 0.5 cm.

A polymer pigment obtained by grinding the above-mentioned crude color masterbatch or the above-mentioned color masterbatch product.

In one embodiment, the polymer pigment has a particle size of 0.01 μm to 100 μm.

For the preparation method of the above-mentioned mixture of a fused-ring aromatic pigment and a polymer material, according to intermiscibility, processing temperature and polarity, different thermoplastic polymer materials can be selected and mixed with reactants (an acid anhydride-functionalized fused-ring aromatic compound derivative, an o-diamine compound and a catalyst) for generating a fused-ring aromatic pigment; by adjusting the reaction molar ratio of the raw materials and the dosages of the raw materials in the whole reaction system, the mixture of the reactants and the polymer materials can be extruded or kneaded to obtain a mixture of the fused-ring aromatic pigment and the polymer material in one step. Compared with the pigment, the raw material reactants of the pigment have better dispersity in the polymer material so that the pigment can be directly generated and uniformly dispersed in the polymer material through extruding or kneading. Moreover, in the extruding or kneading process, no solvent is required and an o-diamine compound is also almost completely consumed, so the obtained mixture does not need to be separated and purified. Therefore, the generation of the “three waste” in traditional pigment synthesis processes is avoided, the process flow is greatly simplified, the energy consumption and labor required can be reduced, and production costs can also be lowered.

In addition, in the preparation method of the above-mentioned mixture of a fused-ring aromatic pigment and a polymer material, the reactants for generating different pigments can be selected according to the needs, and based on the possible colors of the products, more colors can be obtained. Compared with the traditional method of mixing different pigments, the method of the application can obtain a mixture of a more uniform color.

In addition, since the raw material reactants of the pigment have better dispersibility in the polymer material, the pigment of the application can be directly formed and uniformly dispersed in the thermoplastic polymer material by extruding or kneading. By mixing the pigment and the thermoplastic polymer material, the mixture obtained in the application has better intermiscibility.

### BRIEF DESCRIPTION OF THE SEVERAL VIEWS OF THE DRAWINGS

FIG. 1 shows the reflection spectrogram of a crude color masterbatch prepared according to Example 4 mixed with ABS;

FIG. 2 shows the reflection spectrogram of a crude color masterbatch prepared according to Example 7 mixed with ABS;

FIG. 3 shows the reflection spectrogram of a crude color masterbatch prepared according to Example 9 mixed with ABS;

FIG. 4 shows the reflection spectrogram of a crude color masterbatch prepared according to Example 10 mixed with ABS;

FIG. 5 shows the reflection spectrogram of a crude color masterbatch prepared according to Example 13 mixed with ABS;

FIG. 6 shows the reflection spectrogram of a crude color masterbatch prepared according to Example 14 mixed with ABS;

FIG. 7 shows the reflection spectrogram of a crude color masterbatch prepared according to Example 15 mixed with ABS; and

FIG. 8 shows the reflection spectrogram of a crude color masterbatch prepared according to Example 16 mixed with ABS.

### DETAILED DESCRIPTION OF THE INVENTION

For easy understanding of the invention, the invention will be described more comprehensively below and preferred embodiments of the invention are also provided. However, the present disclosure may be implemented in many different forms and is not limited to the embodiments described herein. On the contrary, these embodiments are provided to make the contents disclosed by the present disclosure understood more thoroughly and comprehensively.

Unless otherwise defined, all technical and scientific terms used herein have the same meaning as commonly understood by those skilled in the technical field to which the present disclosure belongs. The terms used herein in the specification of the present disclosure are for the purpose of describing specific embodiments only but not intended to limit the present disclosure. The term “and/or” as used herein includes any and all combinations of one or more of the associated listed items.

According to an embodiment, provided is a preparation method of a mixture of a fused-ring aromatic pigment and a polymer material, including the following steps:

mixing a thermoplastic polymer material and reactants for forming a fused-ring aromatic pigment, and carrying out kneading or extruding to obtain a mixture of the fused-ring aromatic pigment and the polymer material.

The reactants for forming the fused-ring aromatic pigment include an acid anhydride-functionalized fused-ring aromatic compound derivative, an o-diamine compound and a catalyst.

It should be noted that during the kneading or extruding process, the acid anhydride-functionalized fused-ring aromatic compound derivative and the o-diamine compound can react under the action of the catalyst to obtain the fused-ring aromatic pigment.

Further, the acid anhydride-functionalized fused-ring aromatic compound derivative is at least one of the following compounds:

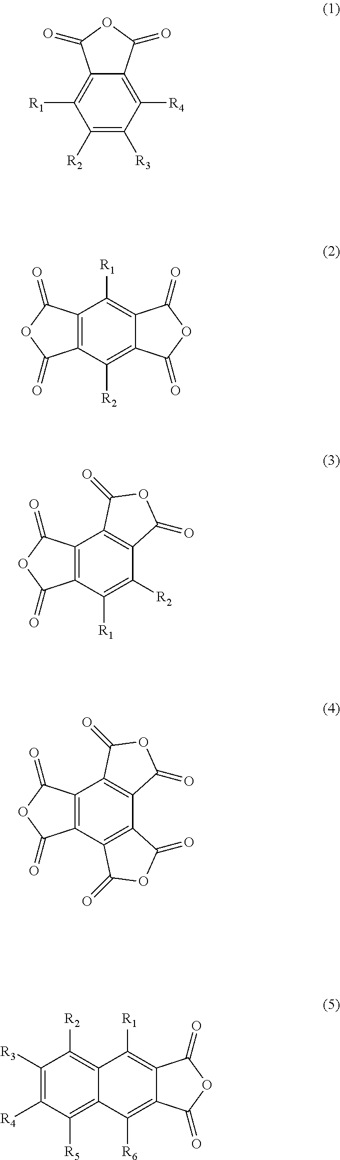

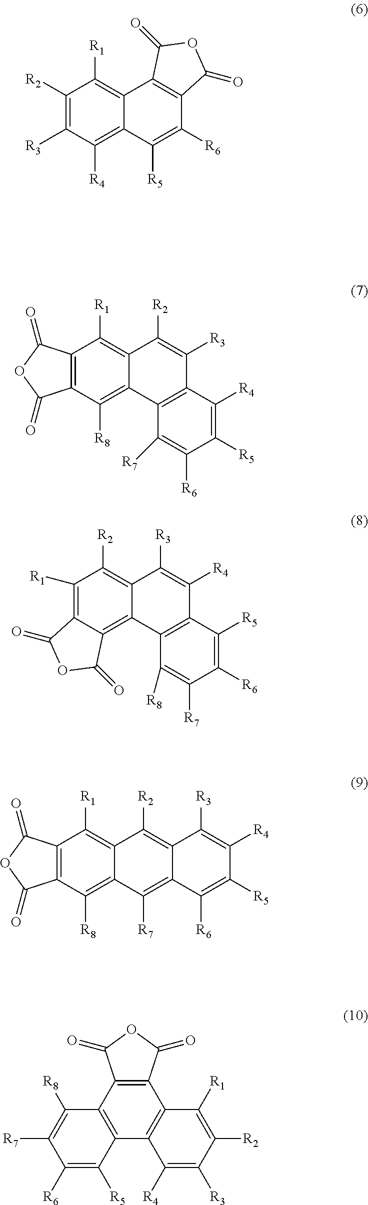

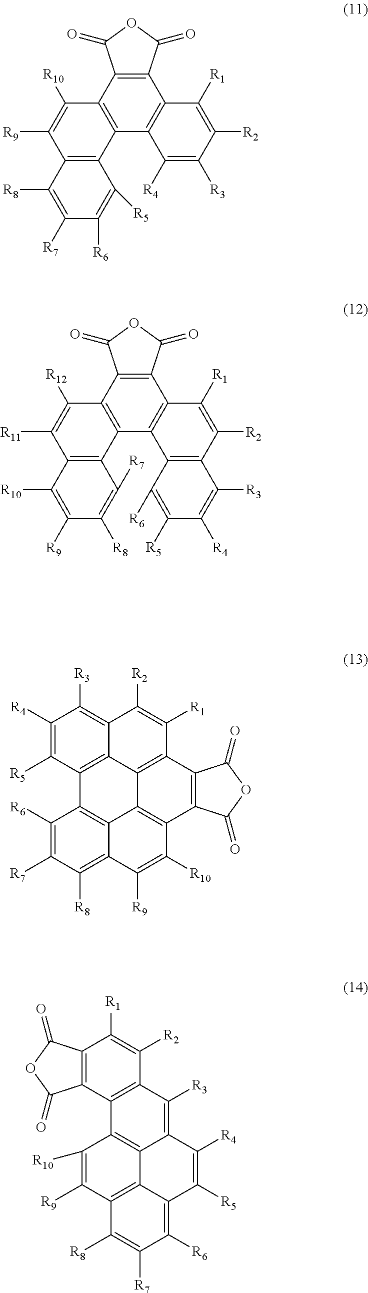

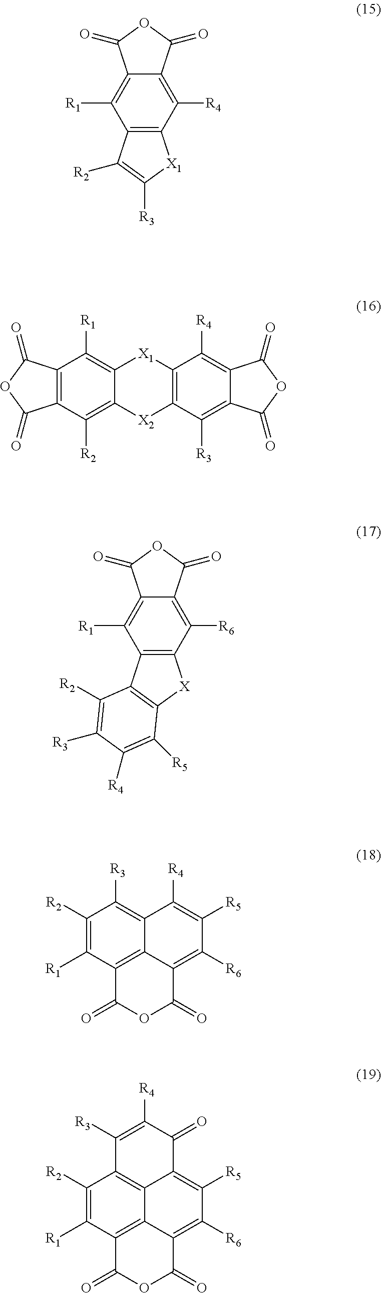

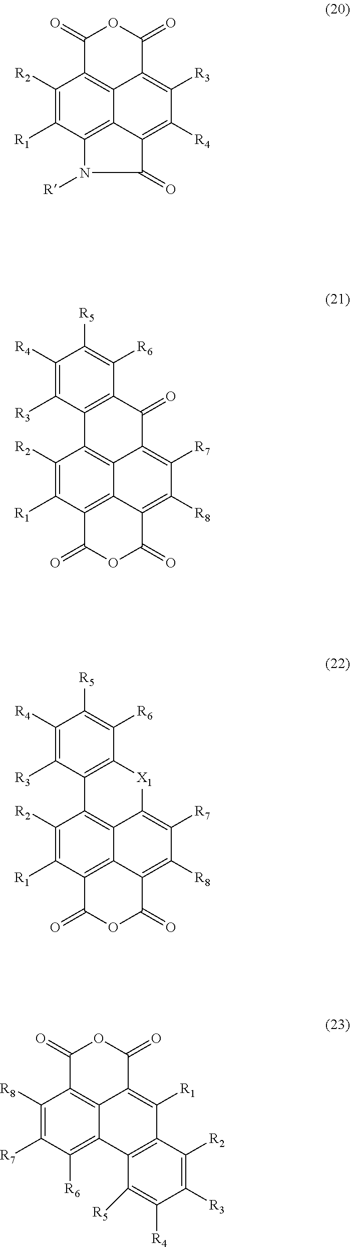

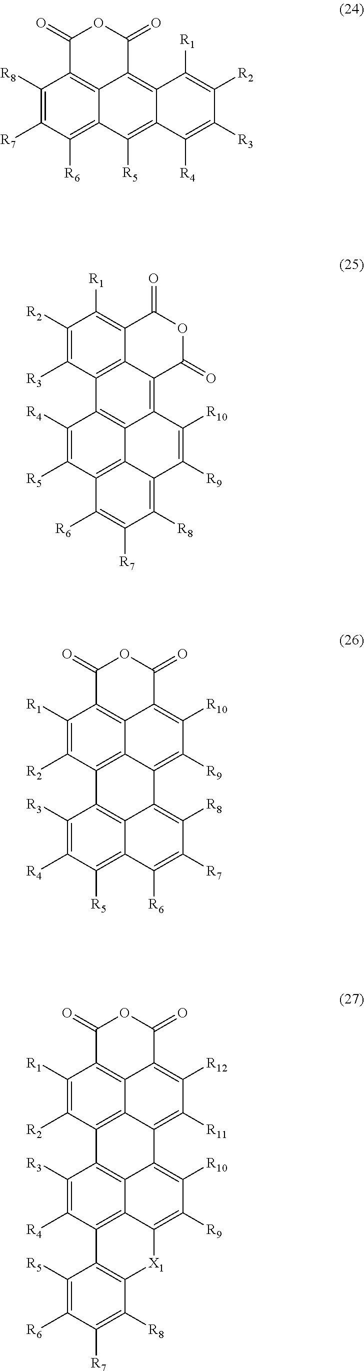

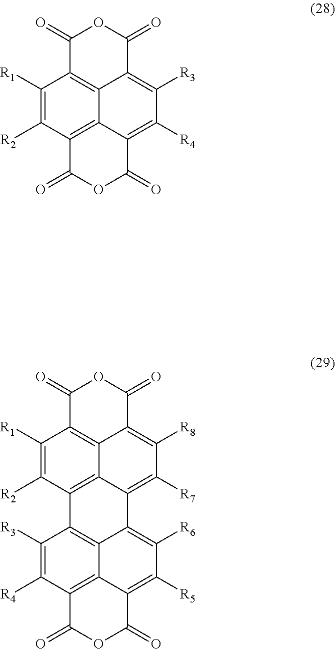

wherein, R₁ to R₁₂ each independently represents one of H, halogen, amido group, substituted amido group, alkyl group with 1 to 30 carbon atoms, alkoxy group with 1 to 20 carbon atoms, phenolic hydroxyl group, substituted phenolic hydroxyl group, phenyl group, substituted phenyl group, naphthyl group, substituted naphthyl group, mercapto group, substituted mercapto group, cyano group, silicyl group, carboxylic ester group, sulfonic acid group, sulphonate group, phosphoric acid group, and phosphate group;

R′ represents one of H, alkyl group with 1 to 30 carbon atoms, alkoxy group with 1 to 20 carbon atoms, phenyl group, substituted phenyl group, naphthyl group, substituted naphthyl group, and silicyl group;

X1 and X2 each independently represents one of CH₂, CHR″, CR″R′″, NR″, O, S, S═O and SO₂, and R″ and R′″ each independently represents one of H, alkyl group with 1 to 30 carbon atoms, alkoxy group with 1 to 20 carbon atoms, and substituted aryl.

Further, the o-diamine compound is at least one of the following compounds:

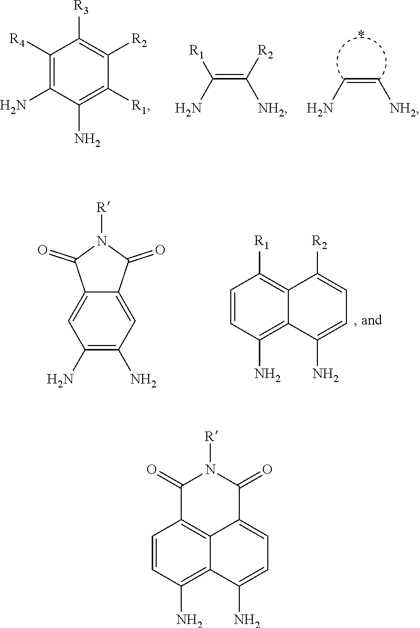

wherein, R₁, R₂, R₃, and R₄ each independently represents at least one of H, halogen, cyano group, nitro group, aldehyde group, carboxyl group, acid anhydride, amide, imide, ester group, alkyl group, alkoxy group, and mercapto group;

R′ independently represents one of H, alkyl group with 1 to 30 carbon atoms, alkoxy group with 1 to 20 carbon atoms, and substituted aryl;

X is a five- or six-membered ring structure containing S, N, O, CO, SO, SO₂ or C═C groups.

In this embodiment, the fused-ring aromatic pigment in the mixture of the fused-ring aromatic pigment and the polymer material is at least one of the following compounds:

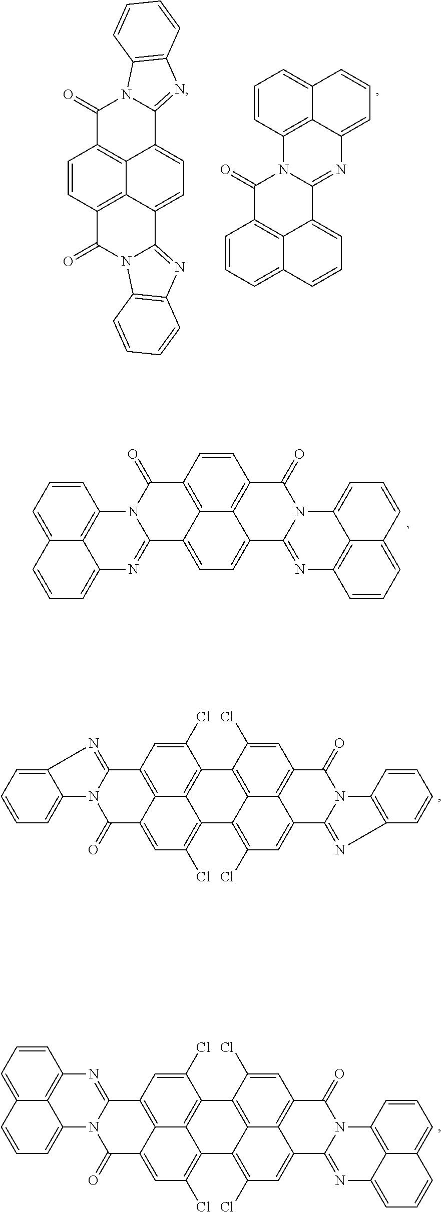

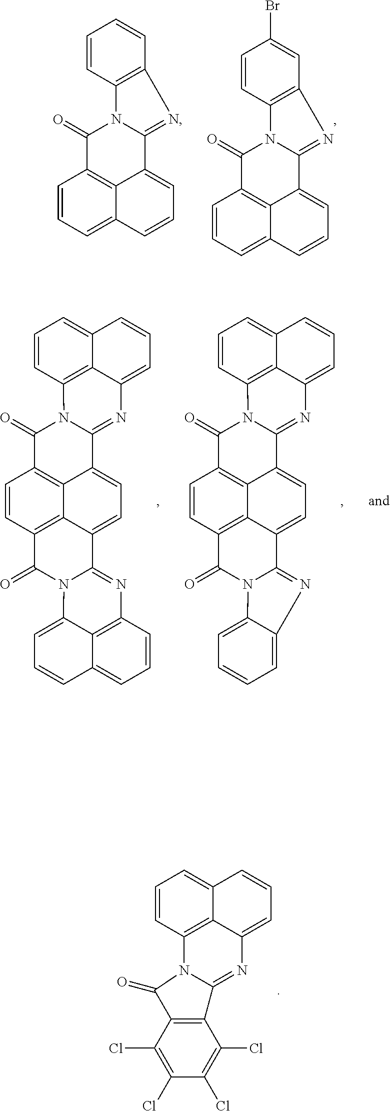

It can be understood that the fused-ring aromatic pigment that can be generated in the application is not limited to the ones described above, and fused-ring aromatic pigments that can be obtained by reacting any acid anhydride-functionalized fused-ring aromatic compound derivatives with o-diamine compounds are all covered within the scope of the application, and they will not be enumerated here.

Further, the mass content of the fused-ring aromatic pigment in the mixture of the fused-ring aromatic pigment and the polymer material is 0.1% to 50%.

It can be understood that the molar ratio of the acid anhydride functional groups in the o-diamine compound and the acid anhydride-functionalized fused-ring aromatic compound derivative is controlled to be 1:(1 to 1.1) and the molar ratio of the catalyst to the acid anhydride-functionalized fused-ring aromatic compound derivative is controlled to be (0.1 to 10):1, so that the o-diamine compound and the acid anhydride-functionalized fused-ring aromatic compound derivative are basically completely reacted under the action of the catalyst, and the content of the o-diamine compound in the obtained mixture is lower than 10 ppm, thus reducing the toxicity and carcinogenicity of the product.

Further, the catalyst is at least one of a water scavenger (such as quicklime, activated alumina, calcium chloride, calcium sulfate, lithium chloride, sodium chloride, sodium sulfate, and more), a Lewis acid, a Lewis base (such as zinc chloride, zinc acetate, titanium chloride, alkylamines, and more) and a metal oxide (such as titanium oxide, zinc oxide, aluminum oxide, and more).

Further, the thermoplastic polymer material is at least one of polyolefin, polyaromatic substituted olefin, polyacrylate, polyhalogenated olefin, polyimide, polyester, polyoxymethylene, polylactic acid, acrylonitrile-butadiene-styrene copolymer (ABS resin), polybenzo Imidazole (PBI), polyetheretherketone (PEEK), polyetherimide (PEI), polyethersulfone (PES), polyphenylene Ether (PPO), polyphenylene Sulfide (PPS), polyvinylidene Fluoride (PVDF), polycarbonate (PC), and polyimide (PA).

Further, extruding is carried out in an extruder. The extruder can be a single-screw extruder or a twin-screw extruder.

Further, the extruding temperature is 120° C. to 330° C. in a feeding section, 150° C. to 360° C. in an extruding section, and 180° C. to 380° C. in a sample discharging section along a material advancing direction.

It can be understood that the temperature curve of the extruding reaction is adapted to the total length of the extruder. For example, for a twin-screw extruder with 10 sections, the temperature curve application area of the extruding reaction is shown in the following table:

| Sample | | | | | | | | | | | Sample |
|---|---|---|---|---|---|---|---|---|---|---|---|
| feeding | 1 | 2 | 3 | 4 | 5 | 6 | 7 | 8 | 9 | 10 | discharging |
| Temperature/ | 160- | 170- | 180- | 190- | 190- | 190- | 190- | 190- | 190- | 200- | 200- |
| ° C. | 330 | 360 | 370 | 380 | 380 | 380 | 380 | 380 | 380 | 380 | 380 |

For a single-screw extruder with 10 sections, the temperature curve application area of the extruding reaction is shown in the following table:

| Sample | | | | | | | | | | | Sample |
|---|---|---|---|---|---|---|---|---|---|---|---|
| feeding | 1 | 2 | 3 | 4 | 5 | 6 | 7 | 8 | 9 | 10 | discharging |
| Temperature/ | 160- | 170- | 180- | 190- | 190- | 190- | 190- | 190- | 190- | 200- | 200- |
| ° C. | 330 | 360 | 360 | 380 | 380 | 380 | 380 | 380 | 380 | 380 | 380 |

Certainly, the above temperature curve can also be applied to extruders with more or less sections, usually depending on the selected reactants for generating the fused-ring aromatic pigment and the thermoplastic polymer material.

For the preparation method of the above-mentioned mixture of a fused-ring aromatic pigment and a polymer material, according to intermiscibility, processing temperature and polarity, different thermoplastic polymer materials can be selected and mixed with reactants (an acid anhydride derivative, an o-diamine compound and a catalyst) for generating a fused-ring aromatic pigment; by adjusting the reaction molar ratio of the raw materials and the dosages of the raw materials in the whole reaction system, the mixture of the reactants and the polymer materials can be extruded or kneaded to obtain a mixture of the fused-ring aromatic pigment and the polymer material in one step. Compared with the pigment, the raw material reactants of the pigment have better dispersity in the polymer material so that the pigment can be directly generated and uniformly dispersed in the polymer material through extruding or kneading. Moreover, in the extruding or kneading process, no solvent is required and an o-diamine compound is also almost completely consumed, so the obtained mixture does not need to be separated and purified. Therefore, the generation of the “three waste” in traditional pigment synthesis processes is avoided, the process flow is greatly simplified, the energy consumption and labor required can be reduced, and production costs can also be lowered.

It will be appreciated that by selecting reactants used to form the different pigments, and based on the possible color of the product, non-primary colors can be formulated during the extruding or kneading process. For example, black color can be obtained using reactants that produce red, yellow, and blue pigments; and green color can be obtained using reactants that produce yellow and blue pigments. Compared with the traditional method of mixing different pigments, the color of the mixture obtained by the application is more uniform.

In addition, since the raw material reactants of the pigment have better dispersibility in the polymer material, the pigment of the application can be directly formed and uniformly dispersed in the thermoplastic polymer material by extruding or kneading. Compared with the method of generating a pigment first and then mixing the pigment and a thermoplastic polymer material, the preparation method of the application can produce a mixture having better intermiscibility.

Further, the above-mentioned mixture of the fused-ring aromatic pigment and the polymer material can be cooled, dried and diced to obtain a crude color masterbatch.

Further, in order to obtain a high-quality color masterbatch products, additives (such as flame retardants, fluorescent whitening agents, UV absorbers, antioxidants, lubricants, plasticizers, antibacterial agents and other fillers required for the polymer material) required for traditional color masterbatches are mixed with the above-mentioned crude color masterbatch, and then the mixture is extruded, cooled, dried and diced to obtain a color masterbatch product. Or selectively the above-mentioned additives are mixed with the raw materials of the mixture of the fused-ring aromatic pigment and the polymer material, and the resulting mixture is then extruded, cooled, dried and diced to obtain a color masterbatch product.

The color masterbatch product has a particle size of 200 μm to 0.5 cm.

A high-quality polymer pigment can be obtained by further grinding the above-mentioned crude color masterbatch or color masterbatch product.

The polymer pigment has a particle size of 0.01 μm to 100 μm.

The following are specific examples.

In order to better test the performance of the crude color masterbatch, the crude color masterbatch having a concentration of 1% is mixed with ABS, and the resulting mixture is then subjected to injection molding to obtain an opaque sheet. The reflection spectrum of the opaque sheet is tested.

### Examples 1 to 6

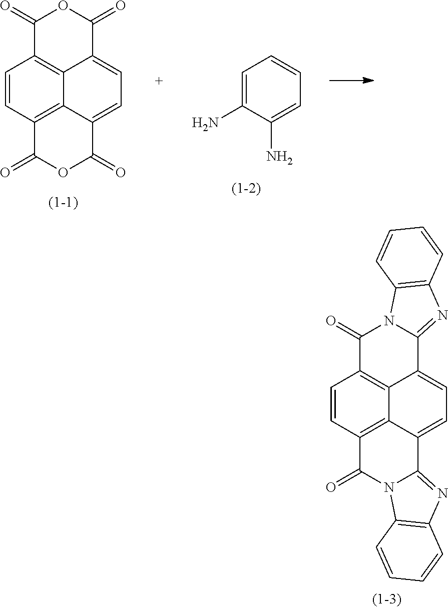 [SMILES: O=C1OC(=O)c2ccc3c4c(ccc1c24)C(=O)OC3=O ; Nc1ccccc1N ; O=c1c2ccc3c(=O)n4c5ccccc5nc4c4ccc(c2c34)c2nc3ccccc3n12]

Examples 1 to 6 are all implemented in the following way.

0.5 kg of PMMA, Compound (1-1) (32 g, 119 mmol), Compound (1-2) (25 g, 231 mmol) and a catalyst were mixed and extruded on a single-screw extruder to react, and the reaction product was then cooled, dried and diced to obtain a crude color masterbatch containing Compound (1-3).

Examples 1 to 6 are basically the same except for the type and dosage of the catalyst, as shown in Table 1:

TABLE 1

| Example | Catalyst | Color of product |
|---|---|---|
| 1 | — | Orange |
| 2 | CaO 4 eq | Yellow-orange |
| 3 | Znic acetate 0.08 eq | Orange |
| 4 | Oxalic acid 6 eq, CaO 4 eq | Orange-red |
| 5 | Oxalic acid 6 eq | Yellow-orange |
| 6 | CaO 4 eq, Znic acetate 0.08 eq | Yellow-orange |

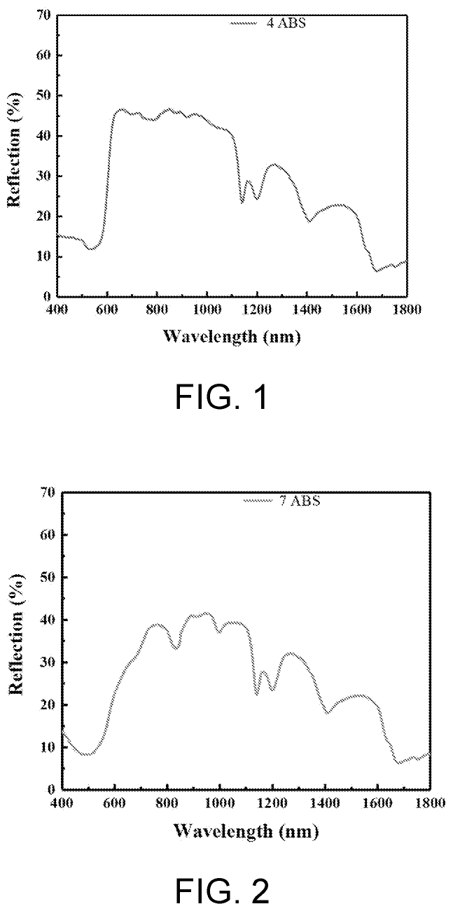

FIG. 1 illustrates the reflection spectrogram of a 1 mm thick plastic sheet obtained by mixing ABS with the crude color masterbatch prepared in Example 4 with a concentration of 1% and injection molding. As can be seen from FIG. 1, its absorption is mainly in the blue light region to the orange light region, which is similar to that of a mixture of Pigment Orange 43 and

Pigment Red 194.

### Example 7

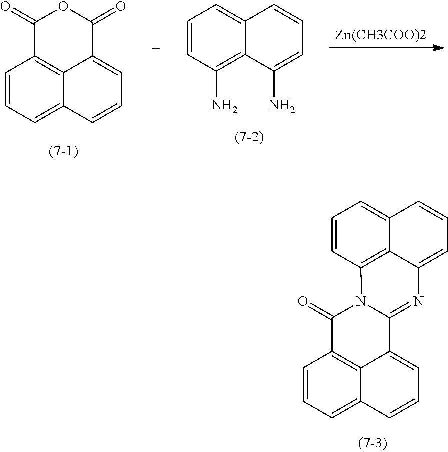

0.5 kg of PMMA, Compound (7-1) (30 g, 152 mmol), Compound (7-2) (23.5 g, 148 mmol) and a catalyst zinc acetate (3.5 g, 19 mmol) were mixed and extruded on a twin-screw extruder to react, and the reaction product was then cooled, dried and diced to obtain a yellow-red crude color masterbatch containing Compound (7-3).

With reference to FIG. 2, the figure illustrates the reflection spectrum of the crude color masterbatch (having a concentration of 1%) prepared in Example 7 mixed with ABS. It can be seen from FIG. 2 that the absorption of this material is mainly in the green light region.

### Example 8

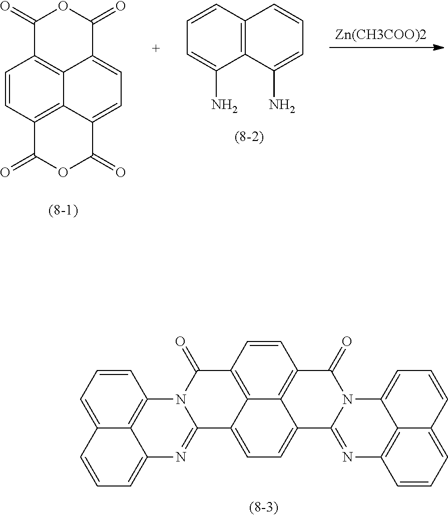

0.5 kg of PC, Compound (8-1) (28 g, 104 mmol), Compound (8-2) (32 g, 203 mmol) and a catalyst zinc acetate (4.7 g, 26 mmol) were mixed and extruded on a single-screw extruder to react, and the reaction product was then cooled, dried and diced to obtain a dark-blue crude color masterbatch containing Compound (8-3).

### Example 9

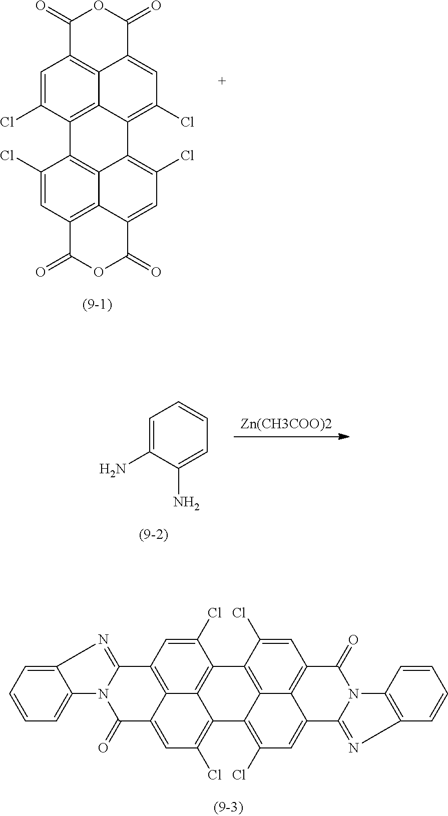

0.5 kg of PET, Compound (9-1) (40 g, 75 mmol), Compound (9-2) (16 g, 148 mmol) and a catalyst zinc acetate (3.4 g, 19 mmol) were mixed and extruded on a single-screw extruder to react, and the reaction product was then cooled, dried and diced to obtain a purple-black crude color masterbatch containing Compound (9-3).

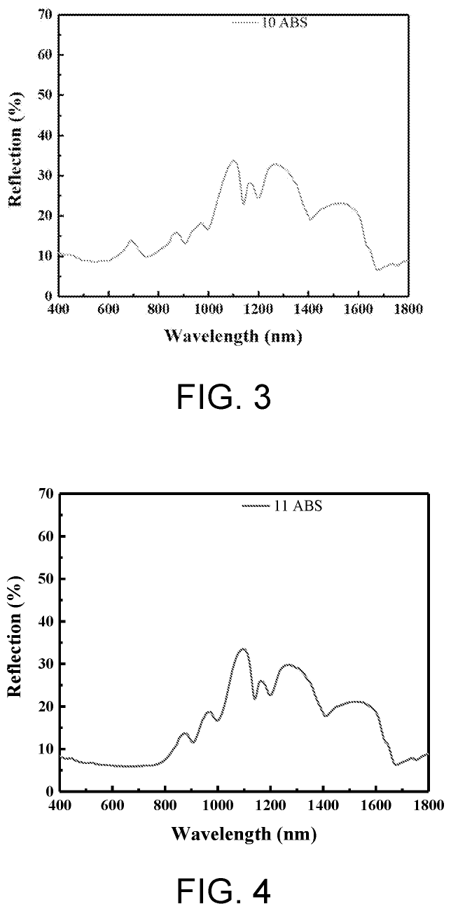

With reference to FIG. 3, the figure illustrates the reflection spectrum of the crude color masterbatch (having a concentration of 1%) prepared in Example 9 mixed with ABS. It can be seen from FIG. 3 that the absorption of this material is mainly in the blue light region to the red light region.

### Example 10

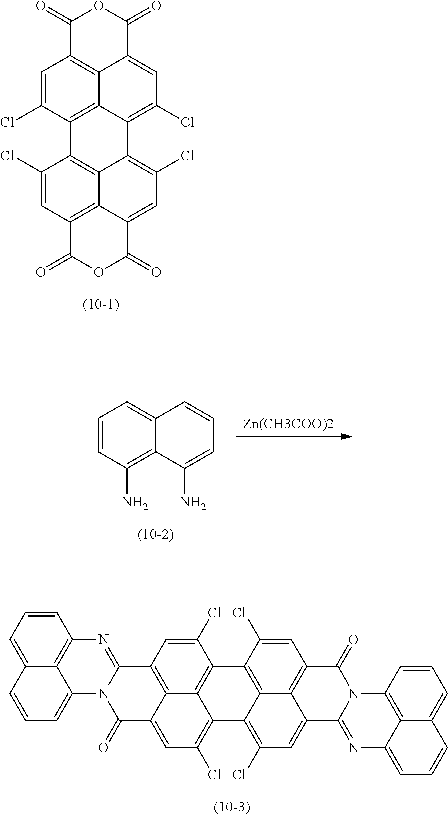

0.5 kg of PA, Compound (10-1) (36 g, 68 mmol), Compound (10-2) (21 g, 133 mmol) and a catalyst zinc acetate (3 g, 16 mmol) were mixed and extruded on a twin-screw extruder to react, and the reaction product was then cooled, dried and diced to obtain a blue-black crude color masterbatch containing Compound (10-3).

With reference to FIG. 4, the figure illustrates the reflection spectrum of the crude color masterbatch (having a concentration of 1%) prepared in Example 10 mixed with ABS. It can be seen from FIG. 4 that the material has strong absorption to visible light, but very weak absorption to infrared light. It can be seen that the material is a very good “cold” black material, i.e., a black material that does not absorb infrared light.

### Example 11

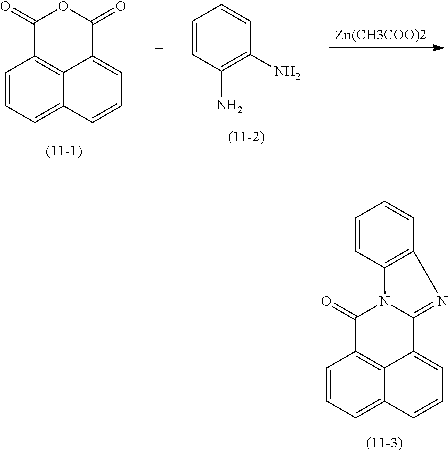

1 kg of PMMA, Compound (11-1) (10 g, 50 mmol), Compound (11-2) (5.4 g, 50 mmol) and a catalyst zinc acetate (3 g, 16 mmol) were mixed and extruded on a single-screw extruder to react, and the reaction product was then cooled, dried and diced to obtain a pink crude color masterbatch containing Compound (11-3).

### Example 12

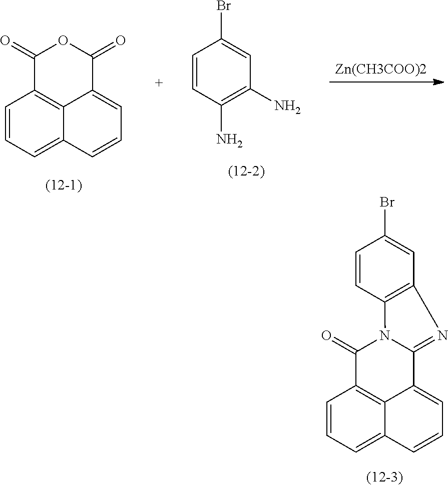

1 kg of PMMA, Compound (12-1) (10 g, 50 mmol), Compound (12-2) (9.4 g, 50 mmol) and a catalyst zinc acetate (3.5 g, 19 mmol) were mixed and extruded on a single-screw extruder to react to obtain a grey-red crude color masterbatch containing Compound (12-3).

### Example 13

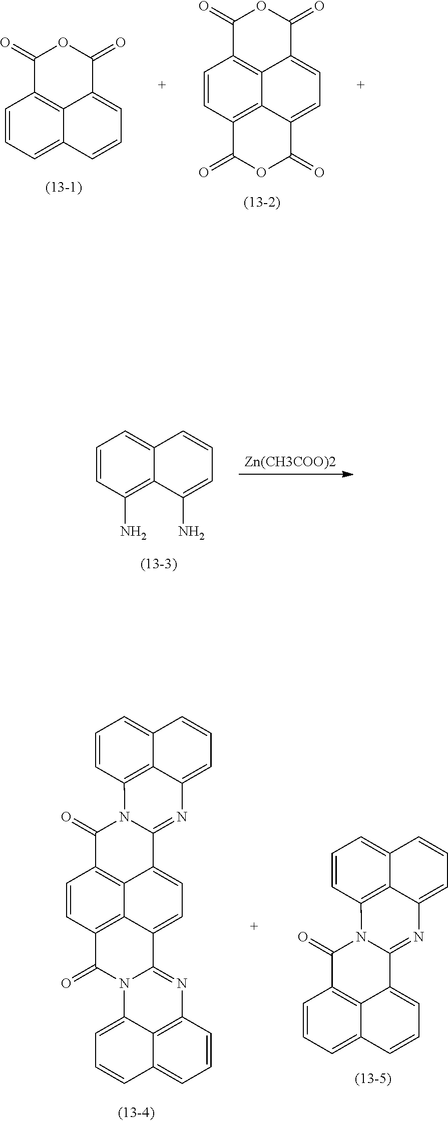

0.5 kg of PMMA, Compound (13-1) (12 g, 60 mmol), Compound (13-2) (16 g, 60 mmol), Compound (13-3) (28 g, 177 mmol), and a catalyst zinc acetate (3.3 g, 18 mmol) were mixed and extruded on a twin-screw extruder to react to obtain a blueish black crude color masterbatch containing Compound (13-4) and Compound (13-5).

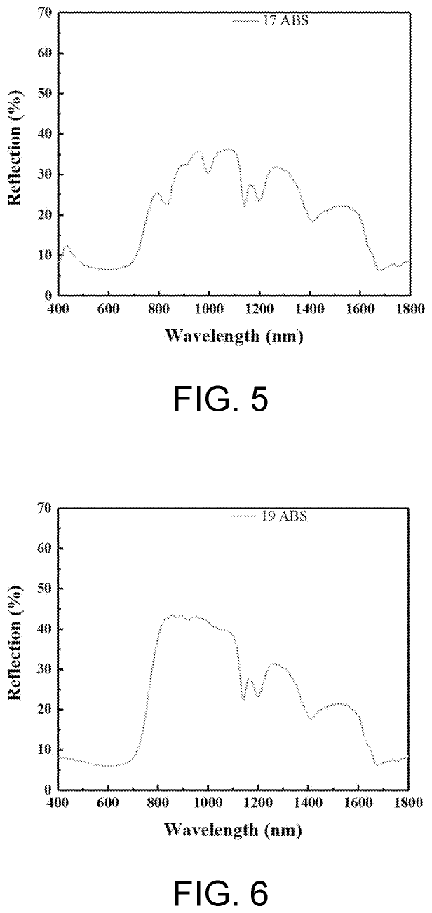

With reference to FIG. 5, the figure illustrates the reflection spectrum of the crude color masterbatch ((having a concentration of 1%) prepared in Example 13 mixed with ABS. It can be seen from FIG. 5 that the material has better “cold” color effect that that in Example 10, has weaker absorption in the infrared region, and is a very good blue-black product that reduces heat generation from sunlight.

### Example 14

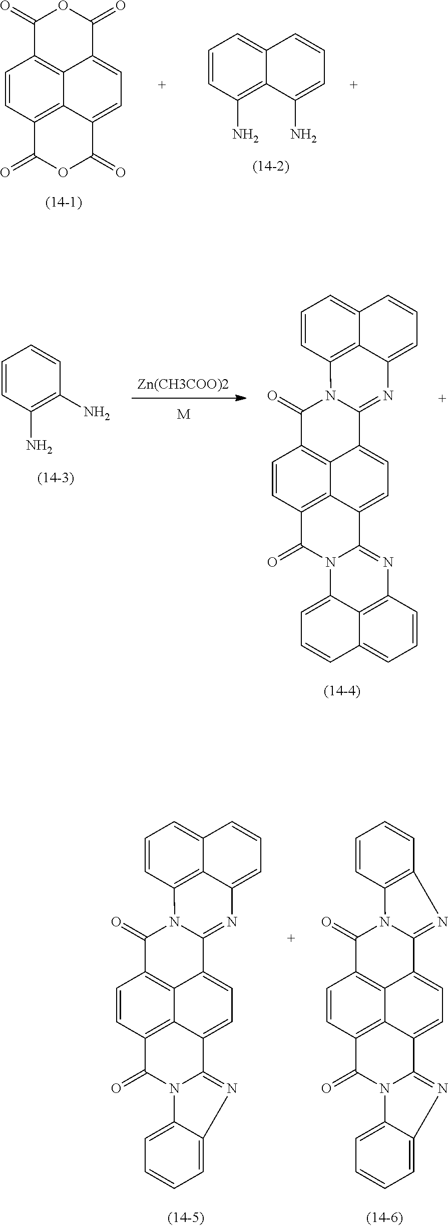

0.5 kg of PMMA, Compound (14-1) (20 g, 75 mmol), Compound (14-2) (11 g, 70 mmol), Compound (14-3) (8 g, 74 mmol), and a catalyst zinc acetate (1.7 g, 9 mmol) were mixed and extruded on a twin-screw extruder to react to obtain a black-green crude color masterbatch containing Compound (14-4), Compound (14-5) and Compound (14-6).

With reference to FIG. 6, the figure illustrates the reflection spectrum of the crude color masterbatch (having a concentration of 1%) prepared in Example 14 mixed with ABS. It can be seen from FIG. 6 that this material is similar to those of Examples 10 and 13, but has better performance and very strong absorption to visible light but weak absorption to infrared light.

### Example 15

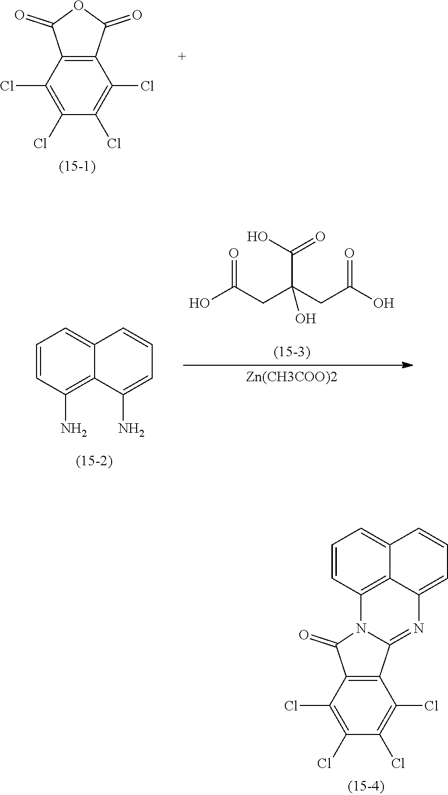 [SMILES: O=C1OC(=O)c2c(Cl)c(Cl)c(Cl)c(Cl)c21 ; O=C(O)CC(O)(CC(=O)O)C(=O)O ; Nc1cccc2cccc(N)c12 ; "Zn(CH3COO)2" ; O=C1c2c(Cl)c(Cl)c(Cl)c(Cl)c2C2=Nc3cccc4cccc(c34)N12]

0.5 kg of PMMA, Compound (15-1) (38 g, 133 mmol), Compound (15-2) (20 g, 127 mmol), and Compound (15-3) (6 g, 31 mmol), which are used as inhibitors for preventing the reaction of halogen and amine, are mixed with a catalyst zinc acetate (2.9 g, 16 mmol), the resulting mixture was then extruded to react in a single-screw extruder, and then the reaction product was cooled, dried and diced to obtain a red crude color masterbatch containing Compound (15-4).

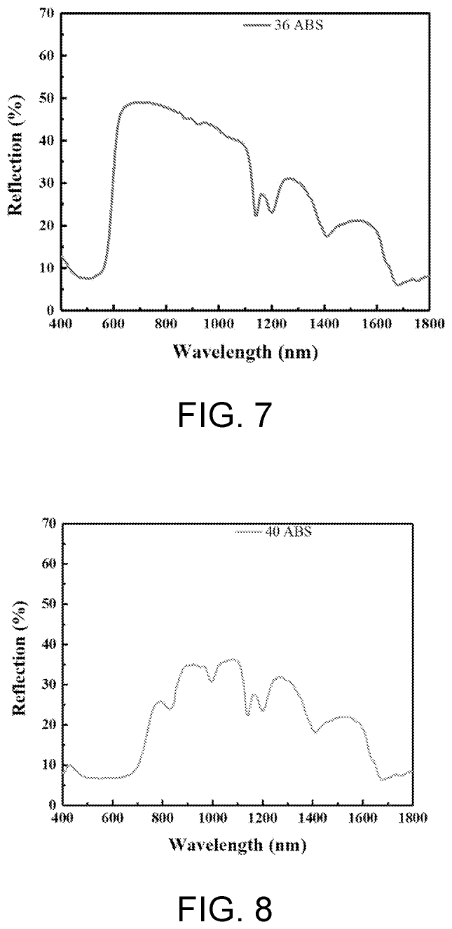

With reference to FIG. 7, the figure illustrates the reflection spectrum of the crude color masterbatch (having a concentration of 1%) prepared in Example 15 mixed with ABS. It can be seen from FIG. 7 that the absorption of this material is only in the blue light region to the orange light region, indicating that this material is a very good coloring agent.

### Example 16

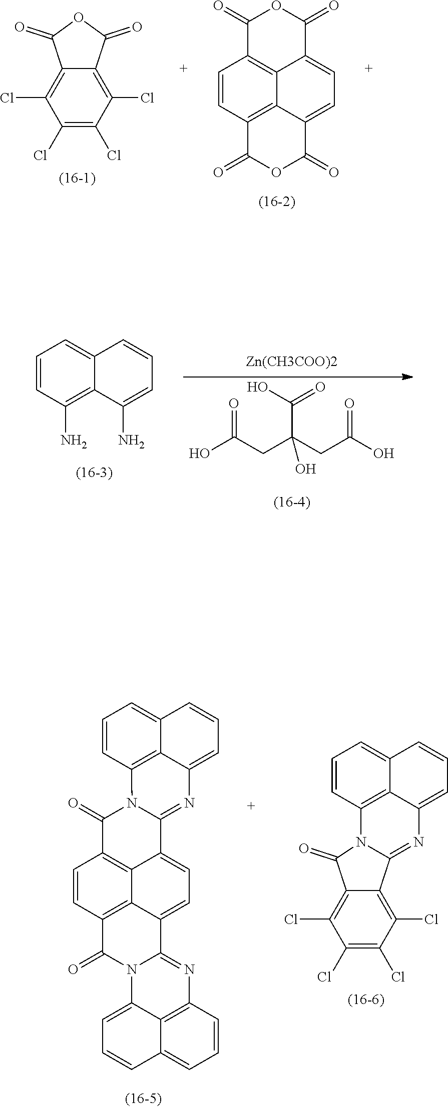

0.5 kg of PMMA, Compound (16-1) (15 g, 52 mmol), Compound (16-2) (14 g, 52 mmol), Compound (16-3) (24 g, 152 mmol), and Compound (16-4) (2.52 g, 13 mmol), which are used as inhibitors for preventing the reaction of halogen and amine, are mixed with a catalyst zinc acetate (2.8 g, 15 mmol), the resulting mixture was then extruded to react in a twin-screw extruder, and then the reaction product was cooled, dried and diced to obtain a black crude color masterbatch containing Compound (16-5) and Compound (16-6).

FIG. 8 illustrates the reflection spectrum of the crude color masterbatch (having a concentration of 1%) prepared in Example 16 mixed with ABS. It can be seen from FIG. 8 that this material is a very good “cold” black product.

In order to test the effect of the extruding reaction, a 0.01 mg/mL solution of o-phenylenediamine and 1,8-diaminenaphthalene (the solvent was composed of water and acetonitrile at a volume ratio of 3:7) was used as a standard sample, and 5 mL of solution of each of the materials (about 10 mg) of Examples 8, 9 and 10 (the solvent was composed of water and acetonitrile at a volume ratio of 3:7) was taken. Within a test range, no 1,8-diaminenaphthalene was found in the materials of Examples 8 and 10, and no o-phenylenediamine was found in the material of Example 9. It shows that this method can obtain a safe crude color masterbatch with a conversion rate of 100%.

The above-described embodiments only show several implementations of the invention, which are more specific and detailed, but not to be construed as limiting the scope of the invention. It should be noted that those of ordinary skill in the art may further make variations and improvements without departing from the conception of the invention, and these all fall within the protection scope of the invention. Therefore, the patent protection scope of the present disclosure should be subject to the appended claims.

What is claimed is:

1. A preparation method of a mixture of a fused-ring aromatic pigment and a polymer material, comprising the following steps:
mixing a thermoplastic polymer material and reactants for forming a fused-ring aromatic pigment, and carrying out kneading or extruding to obtain a mixture of the fused-ring aromatic pigment and the polymer material, the reactants for forming the fused-ring aromatic pigment including an acid anhydride-functionalized fused-ring aromatic compound derivative, an o-diamine compound and a catalyst, a mass content of the fused-ring aromatic pigment in the mixture of the fused-ring aromatic pigment and the polymer material being 0.1% to 50%, a molar ratio of acid anhydride functional groups in the o-diamine compound and the acid anhydride-functionalized fused-ring aromatic compound derivative being 1:(1 to 1.1), a molar ratio of the catalyst to the acid anhydride functionalized fused-ring aromatic compound derivative being (0.01 to 10):1;
wherein the acid anhydride-functionalized fused-ring aromatic compound derivative is at least one of the following compounds: 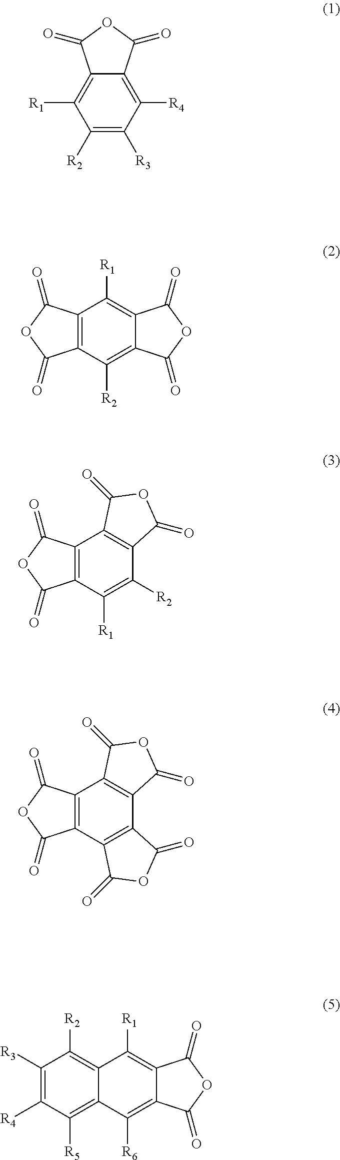 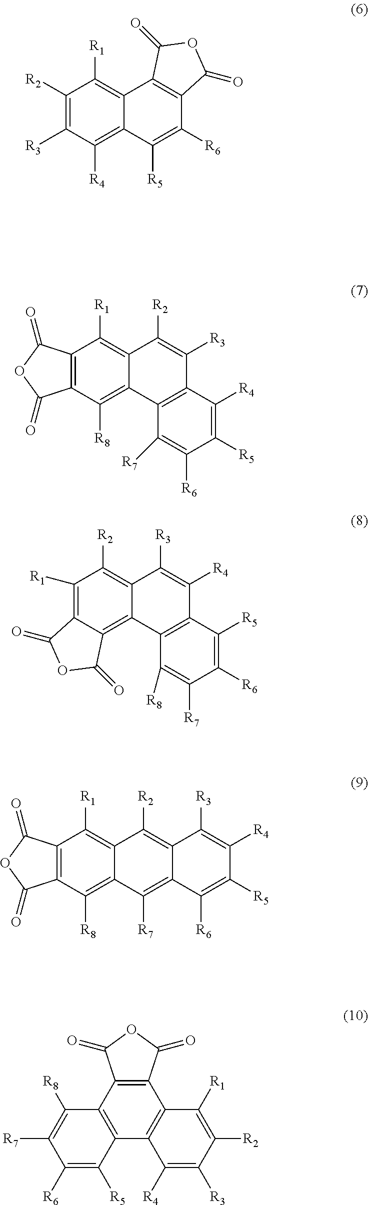 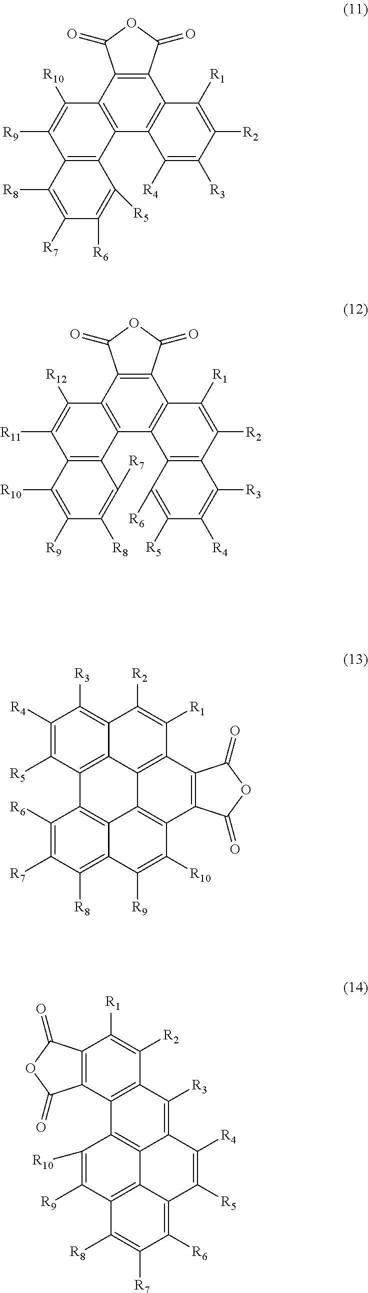 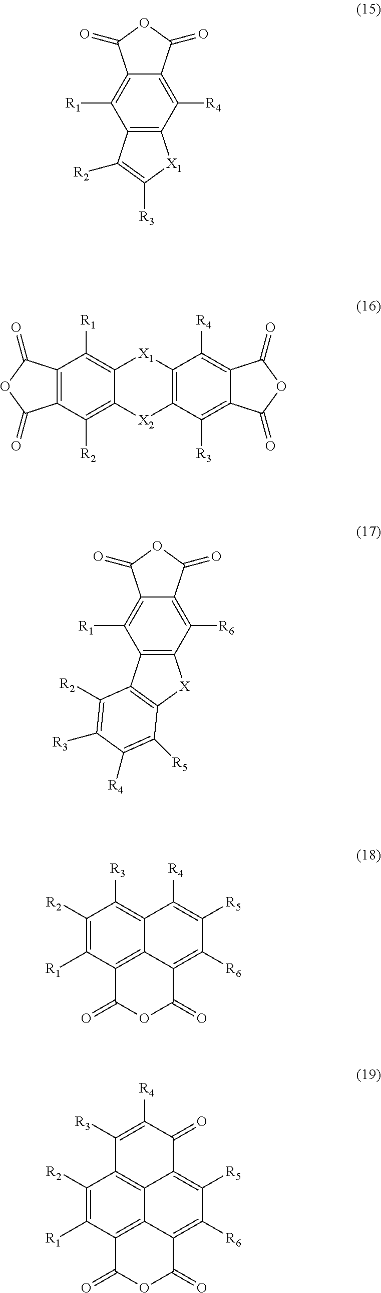 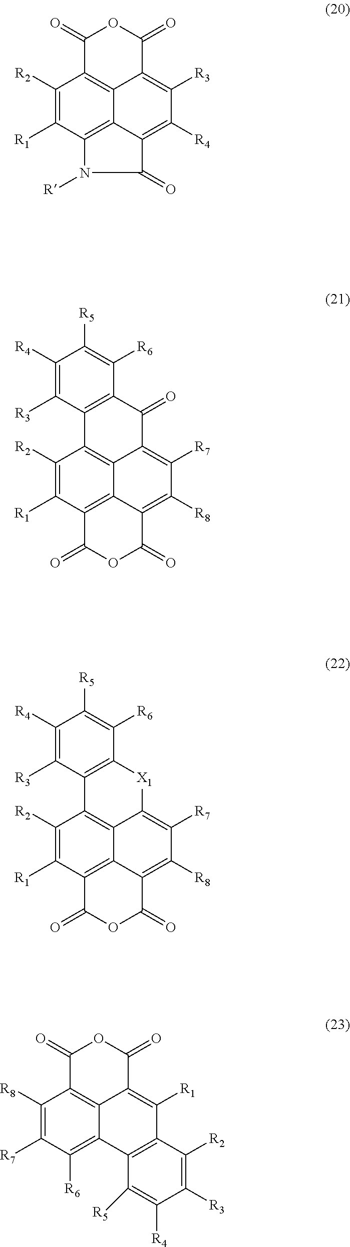 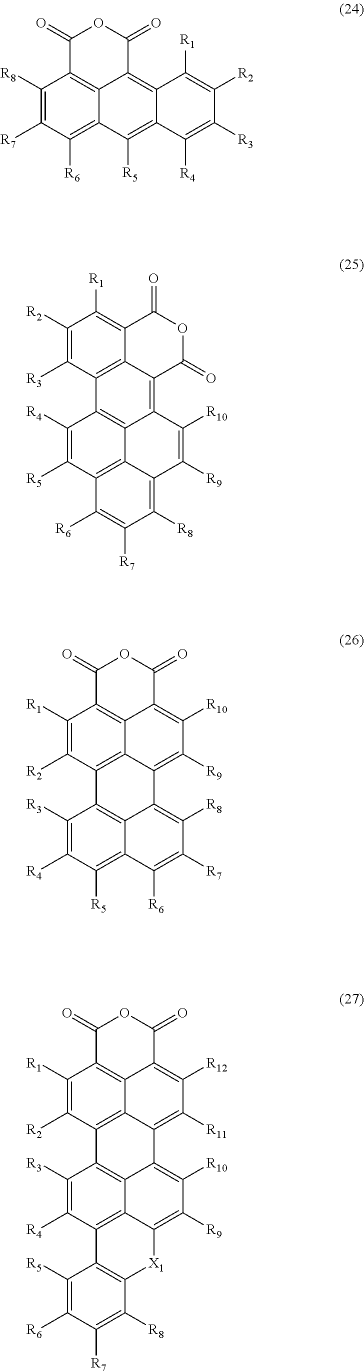 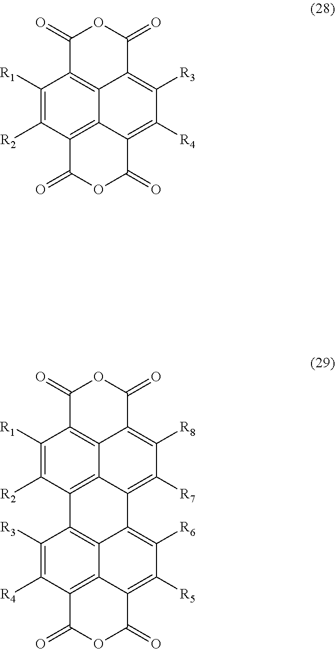
wherein, R₁ to R₁₂ each independently represents one of H, halogen, amido group, substituted amido group, alkyl group with 1 to 30 carbon atoms, alkoxy group with 1 to 20 carbon atoms, phenolic hydroxyl group, substituted phenolic hydroxyl group, phenyl group, substituted phenyl group, naphthyl group, substituted naphthyl group, mercapto group, substituted mercapto group, cyano group, silicyl group, carboxylic ester group, sulfonic acid group, sulphonate group, phosphoric acid group, and phosphate group;
R′ represents one of H, alkyl group with 1 to 30 carbon atoms, alkoxy group with 1 to 20 carbon atoms, phenyl group, substituted phenyl group, naphthyl group, substituted naphthyl group, and silicyl group;
X₁ and X₂ each independently represents one of CH₂, CHR″, CR″R′″, NR″, O, S, S═O and SO₂, and R″ and R′″ each independently represents one of H, alkyl group with 1 to 30 carbon atoms, alkoxy group with 1 to 20 carbon atoms, and substituted aryl.

2. The preparation method of a mixture of a fused-ring aromatic pigment and a polymer material according to claim 1, wherein the o-diamine compound is at least one of the following compounds: 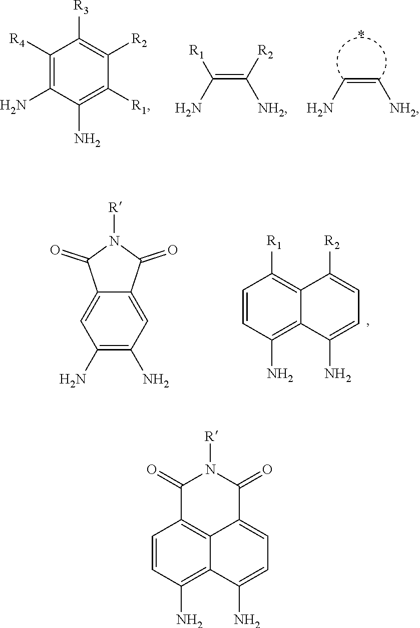
wherein, R₁, R₂, R₃, and R₄ each independently represents at least one of H, halogen, cyano group, nitro group, aldehyde group, carboxyl group, acid anhydride, amide, imide, ester group, alkyl group, alkoxy group, and mercapto group;
R′ independently represents one of H, alkyl group with 1 to 30 carbon atoms, alkoxy group with 1 to 20 carbon atoms, and substituted aryl;
X is a five- or six-membered ring structure containing S, N, O, CO, SO, SO₂ or C═C groups.

3. The preparation method of a mixture of a fused-ring aromatic pigment and a polymer material according to claim 1, wherein the catalyst is at least one of a water scavenger, a Lewis acid, a Lewis base, and a metal oxide.

4. The preparation method of a mixture of a fused-ring aromatic pigment and a polymer material according to claim 1, wherein the extruding temperature is 120° C. to 330° C. in a feeding section, 150° C. to 360° C. in an extruding section, and 180° C. to 380° C. in a sample discharging section along a material advancing direction.

5. A mixture of a fused-ring aromatic pigment and a polymer material prepared by the preparation method according to claim 1.

6. A crude color masterbatch obtained by cooling, drying and dicing the mixture of a fused-ring aromatic pigment and a polymer material according to claim 5.

7. A color masterbatch product obtained by mixing raw materials of the mixture of a fused-ring aromatic pigment and a polymer material according to claim 5 with additives, and carrying out extruding, cooling, drying and dicing.

8. The color masterbatch product according to claim 7, having a particle size of 200 μm to 0.5 cm.

9. A polymer pigment obtained by grinding the crude color masterbatch according to claim 6.

10. The polymer pigment according to claim 9, having a particle size of 0.01 μm to 100 μm.

11. A color masterbatch product obtained by mixing the crude color masterbatch according to claim 6 with additives and then carrying out extruding, cooling, drying and dicing.

12. The color masterbatch product according to claim 11, having a particle size of 200 μm to 0.5 CM.
